(19) United States
(12) Patent Application Publication
(10) Pub. No.: US 2021/0031852 A1
(43) Pub. Date: Feb. 4, 2021

(54) BICYCLE SEAT SUSPENSION ASSEMBLY AND CORRESPONDING BICYCLE SEAT

(71) Applicants: Michal KRISLO, Praha 4 (CZ); Rafael KNOBLOCH, Praha 9 (CZ); Ivan BOROVEC, Praha 6 - Veleslavin (CZ)

(72) Inventor: Rafael KNOBLOCH, Praha 9 (CZ)

(73) Assignees: Michal KRISLO, Praha 4 (CZ); Rafael KNOBLOCH, Praha 9 (CZ); Ivan BOROVEC, Praha 6 - Veleslavin (CZ)

(21) Appl. No.: 16/967,322

(22) PCT Filed: Feb. 4, 2019
(86) PCT No.: PCT/CZ2019/000006

§ 371 Date: Aug. 4, 2020

(30) Foreign Application Priority Data
Feb. 5, 2018 (CZ) PV 2018-59

(51) Int. Cl. B62J 1/08

(52) U.S. Cl. CPC B62J 1/08; F16F 9/0236

(57) ABSTRACT

A bicycle seat suspension assembly includes a gas spring, a seat holder and a device for attachment to seat post. The gas spring is a compression gas spring with dampening, which has a working cylinder with a working cylinder bottom and a working cylinder lid, and a piston arranged in it for sliding. A piston rod sealingly goes through the working cylinder lid. A transfer hole for transfer of working gas between the working cylinder and reservoir created inside the piston rod is arranged in the piston. The transfer hole is provided with a throttle element, which is axially movably placed on a control rod, going sealingly through the lid of the reservoir. The seat holder is attached to the gas spring, not rotably in relation to the working cylinder, and it is fixedly connected with an end of the piston rod, which extends into the working cylinder with its other end bearing the piston. The device for attachment to the seat post is arranged at the closed end forming the working cylinder bottom.

### FIELD OF THE INVENTION

This invention concerns a bicycle seat suspension assembly for installation between the seat post and the seat of a bicycle.

### PRIOR ART

The U.S. Pat. No. 5,829,733 patent discloses an assembly of a bicycle with a standard gas spring for shock dampening. Gas spring has adjustable length and it is housed for sliding in a hollow sleeve arranged along or within a tube of the bicycle frame.

The U.S. Pat. No. 6,220,581 patent discloses a system for adjusting a gas spring for the seat of a bicycle, which uses a gas spring, and is housed inside a conventional seat post. The system allows for quick adjustment of the seat height only by quick shifting of the cyclist's weight from legs to the seat placed in chosen height.

The EP 2729715 patent discloses a gas spring including working cylinder and a piston arranged inside it for sliding, while the working gas is transferable between the working cylinder and reservoir, arranged inside the piston rod consisting of a hollow cylinder, with one of its ends closed by piston. Regulation is possible from outside using a controlling rod for axial setting of gas flow control elements.

The goal of the invention is to provide a solution for suspension of bicycle seat, which would, at low manufacturing costs and small dimensions, allow to control the characteristics of springing and dampening and arrestment from outside, and high extension compared to the total size of the unit and as much as possible used the space under the seat of a bicycle for this purpose.

At the same time, the dampening must happen in the correct direction, according to the ergonomic requirements of riding a bicycle.

These requirements aren't met by the solutions according to the prior art, or they are fulfilled only very insufficiently. Most of the known solutions doesn't have external control for springing and dampening characteristics, or can't be arrested, are too robust, complicated and have high manufacturing and material costs. The distance between seat and seat post is often disproportionally large, and seat post thus has to be inserted deep into the frame. Most of these solutions also apply some form of suspension directly into the seat post without respect to the common laws of physics, and the oblique inclined plane of the seat post, in which some springing or dampening means is placed, in practice often ends by crossing these two planes, which leads to high friction, low efficiency, low user comfort given by inadequate ergonomics, and high failure rate. Most solutions placed in seat post use steel spiral spring and steel angular guides against turning, which is also not suitable regarding the efforts to make the bicycle weight as low as possible. The goal of this invention is to overcome these drawbacks.

### SUMMARY OF THE INVENTION

Above mentioned goals are, according to this invention, reached by the bicycle seat suspension assembly, which comprises gas spring, seat holder and device for attachment to seat post, wherein the gas spring is compression gas spring with dampening, which has a working cylinder with a working cylinder bottom and working cylinder lid, and inside it a piston arranged for sliding, wherein the piston rod goes through the lid of the working cylinder, with sealing, wherein a transfer hole is arranged in the piston for transferring the working gas between the working cylinder and reservoir created inside the piston rod, wherein the transfer hole is equipped with a throttle element, which is axially movably placed on a control rod, going through the lid of the reservoir with sealing (e.g. using an O-ring). The seat holder is attached to the gas spring in a way that it is not rotable regarding the working cylinder, and it is fixedly connected with the end of the piston rod, which extends into the working cylinder by its second end bearing a piston, and device for the attachment to the seat post is arranged at the closed end that forms the bottom of the working cylinder.

Seat holder is preferably fixedly connected to a stack, which is fixedly connected to the lid of the reservoir of the piston rod, wherein this stack is put on the working cylinder and fits into its outer profile to make possible linear axial movement with piston rod relative to the working cylinder, and at the same time to prevent any rotational movement of the stack relative to the working cylinder.

Throttle element is preferably placed on the control rod as axially movable between the upper backstop and lower backstop. Device for attachment to the seat post is preferably formed as a convex shape corresponding to the shape of the seat post cradle, in which there is at least one threaded bore for fixing to the seat post cradle. On the closed end forming the bottom of the working cylinder, a valve for refilling the working gas pressure is preferably arranged. The working gas is preferably air. An adjustment lever is preferably arranged at the end of the control rod protruding out of the reservoir lid.

Bicycle seat with suspension for absorbing of the shocks according to this invention comprises the above-mentioned bicycle seat suspension assembly, wherein the seat runners are fastened to the seat holder using feet drawn tight using screws, and convex shape corresponding to the seat post cradle shape is fixed to the to the seat post cradle using a screw screwed in at least one threaded bore. Control lever of the bicycle seat suspension assembly is preferably manually accessible and adjustable using fingers, and the valve is configured and placed for filling using an inflation pump. At least one third of the length of the bicycle seat suspension assembly is preferably hidden from side view in the space between the runners and the seat. The air spring extension is preferably at least 25 mm.

### BRIEF DESCRIPTION OF THE DRAWINGS

The object of the invention will be described below, based on a specific exemplary embodiment shown on the drawings, where:

FIG. 1 illustrates the bicycle seat suspension assembly according to the invention in section in its longitudinal axis perpendicular to the plane, in which the direction of ride of the bicycle it is installed on lies,

FIG. 2 illustrates the assembly from FIG. 1 in disassembled state in section in its longitudinal axis perpendicular to the ride direction of the bicycle, i.e. according to the line 2-2 on FIG. 6,

FIG. 3 illustrates the working cylinder of the gas spring of the assembly from FIGS. 1 and 2 in section in its longitudinal axis in the plane, in which the ride direction of the bicycle lies, i.e. according to the line 3-3 on FIG. 6,

FIG. 4 illustrates the seat holder of the assembly according to the invention,

FIG. 5 illustrates a perspective view of the stack and working cylinder of the assembly from FIG. 1,

FIG. 6 illustrates a section through the stack and working cylinder from FIG. 5 in assembled state cross the longitudinal axis of the assembly, and

FIG. 7a-7d illustrate a detail from FIG. 1 with throttle element in various positions—different working modes.

### EXAMPLE EMBODIMENT OF THE INVENTION

A specific example embodiment of this invention will be now described. But it will be obvious to any person skilled in the art, that various specific elements could be embodied differently, within the usual engineering skills of an average person skilled in the art. This specific example does not limit the scope of protection, which is delimited by the attached claims.

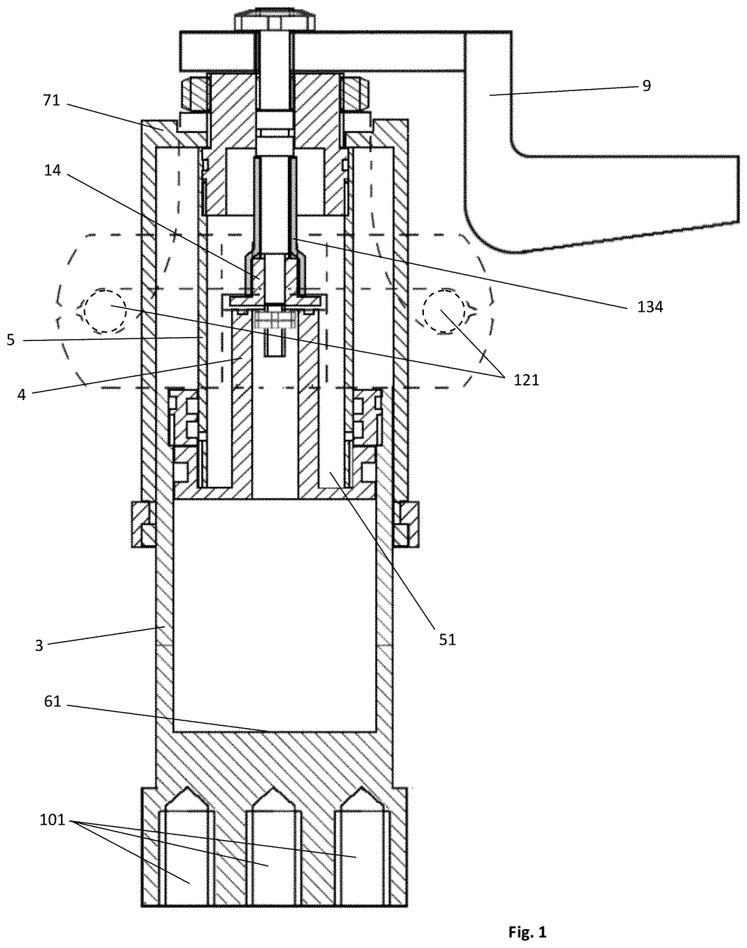

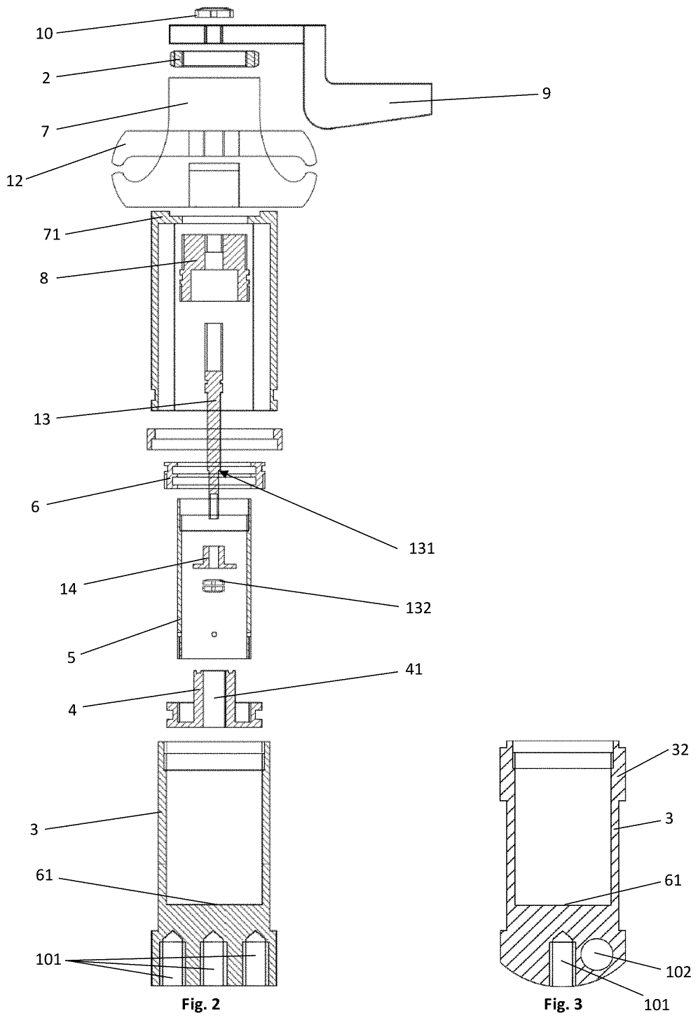

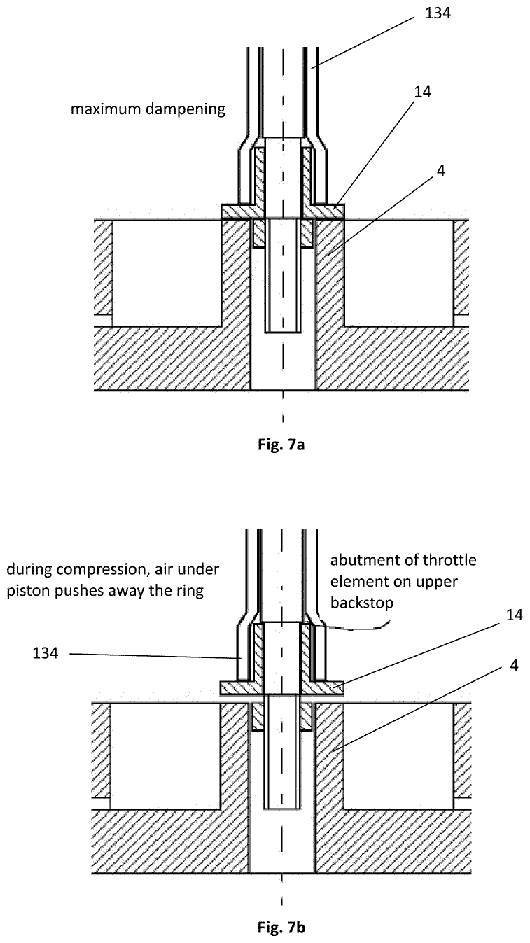

Specific example embodiment of the assembly according to this invention, in section in its longitudinal axis (i.e. longitudinal axis of the pneumatic spring) in a plane perpendicular to the plane, in which the direction of ride of the bicycle it is installed on lies, is illustrated on FIG. 1. FIG. 2 illustrates individual parts of the pneumatic spring and the whole assembly from FIG. 1 in disassembled state, substantially in section in its longitudinal axis perpendicular to the ride direction of the bicycle (i.e. according to the line 2-2 on FIG. 6).

This assembly comprises gas spring, seat holder 7 and device for attachment to the seat post.

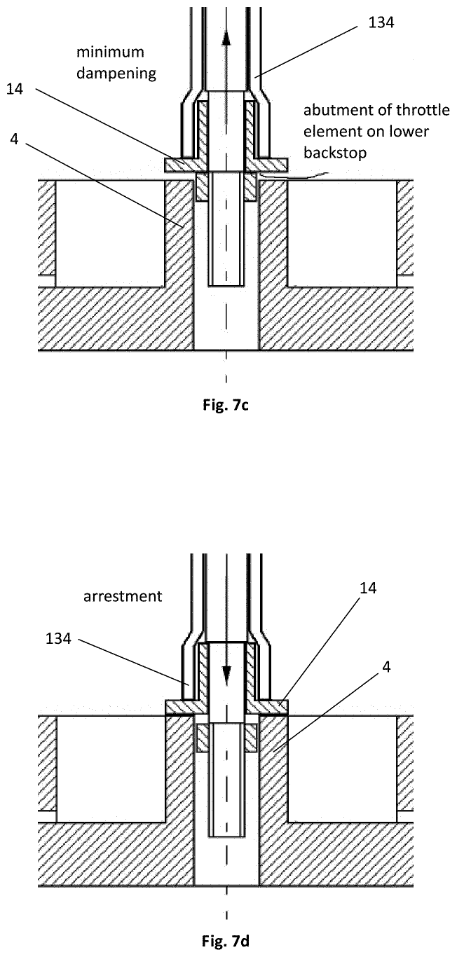

The gas spring is a compression spring with dampening, which consists of the working cylinder 3 with a bottom 61 of the working cylinder and lid 6 of the working cylinder, wherein piston 4 is arranged for sliding in the working cylinder 3. Piston rod 5 goes sealingly through the lid 6 of the working cylinder. Transfer hole 41 for transferring working gas between the working cylinder 3 and reservoir 51 created inside the piston rod 5 is arranged in the piston 4. This transfer hole 41 is equipped with throttle element 14, which is axially movably placed on a control rod 13, going through the lid 8 of the reservoir 51 of the piston rod 5 sealingly (e.g. using an O-ring). A control lever 9 (or other control element) for adjusting the characteristics of springing and dampening, as will be described herein below in connection to FIG. 7a-d, is arranged at the end of the control rod 13 protruding out of the lid 8 of the reservoir 51. Control lever 9 could be attached using a tightening nut 10, which thus forms a backnut for the attachment of the control lever 9. In an example embodiment, this pneumatic spring is formed from lightweight aluminium alloys.

Seat holder 7 is connected to the gas spring without the possibility to rotate against the working cylinder 3, and it is fixedly connected to the end of the piston rod 5, which extends into the working cylinder 3 by its second end bearing the piston 4. In a specific example embodiment, the seat holder 7 is fixedly connected to the shack 71, i.e. it is placed on it and connected to it in such a way that it cannot move relative to it neither axially, nor rotationally, wherein this shack 71 is fixedly connected to the lid 8 of the reservoir 51 of the piston rod 5, wherein this shack 71 is placed on the working cylinder 3 and fits into its outer profile for enabling linear axial movement together with the piston rod 5 relative to the working cylinder 3, and at the same time for preventing any rotational movement of the shack 71 relative to the working cylinder 3.

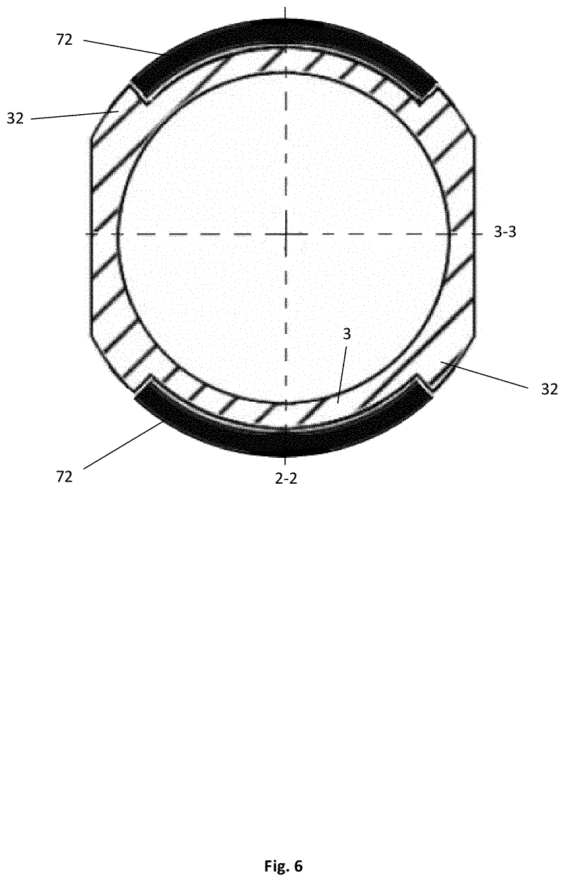

A specific example embodiment of the shack 71 and working cylinder 3 is illustrated in FIG. 5. Shack 71 in this example embodiment comprises two arms 72, wherein two projections 32 are arranged on the working cylinder, along its perimeter, and between them, in this specific example embodiment, are a kind of “dovetailed grooves”, into which, when the shack 71 is put on the working cylinder 3, the arms 72 of the shack 71 fit in such a way, that rotational movement of the shack 71 relative to the working cylinder 3 is impossible, but wherein the shack can axially slide relative to the working cylinder 3. Mutual engagement of the shack arms 72 and protrusions 32 of the working cylinder is best shown on FIG. 6, which illustrates a section through the stack 71 and working cylinder 3 in assembled state across the longitudinal axis of the assembly in the area of the protrusions 32 of the working cylinder (arms 72 and protrusion 32 have mutually compatible shape in this section).

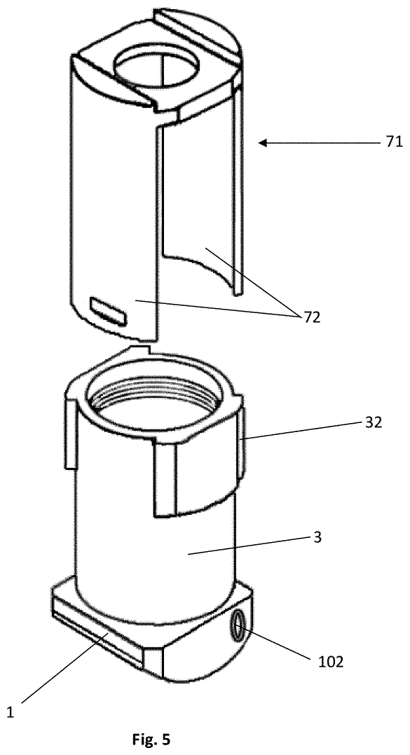

The holder 7 itself is then illustrated on FIG. 4. In this specific example embodiment, it is formed as a yoke, to which feet 12 ale drawn using screws 11, wherein the runners 121 of the seat (see FIG. 1) are attached to the holder 7 by clamping between the holder yoke 7 and feet 12 by tightening the screws 11. A nut 2 is screwed on the thread of the lid 8 of the piston rod 5 and it binds it all together.

With such arrangement, large part of the device is nested into the space between seat runners 121 and the seat, and thus the distance between the seat and seat post is minimal, wherein at least one third of the length of the seat suspension assembly is hidden from side view in the space between seat runners 121 and seat. The whole device measures 115 mm, out of which is 40 mm hidden in the space between seat runners 121 and seat in this specific example embodiment. Extension of the suspension is 30 mm. At quite compact dimensions of the whole device, the extension of such gas spring is completely adequate and adjustment control lever 9 is at the same time well manually accessible for adjustment using fingers.

Instead of manually controlled lever 9, it is alternatively possible to arrange a spool for winding up a wire and to transfer the control using a Bowden cable to the bicycle frame or handlebars.

Device for attachment to the seat post is arranged at the closed end of the working cylinder 3, forming the bottom 61 of the working cylinder, which is formed as a convex shape 1 corresponding to the seat post cradle shape, with at least one threaded bore 101 for fixing to the seat post cradle using at least one screw. Some seat posts have two screws, some have one centre screw, this is why there are preferably three threaded bores 101 in the cradle. The cradle allows inclination of the seat forward/backward in the ride direction. Thanks to the fixing using a conventional seat post cradle, the assembly according to the invention could be applied to most of the present seats and seat posts, wherein the suspension, with correct installation (correct incline) is done perpendicularly to the plane of the terrain, and thus is the crossing of sliding elements prevented and suspension is made in the ergonomically correct direction.

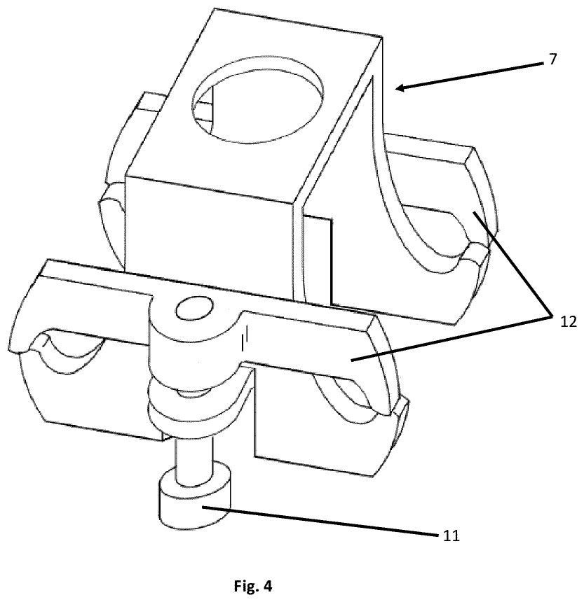

A valve for refilling the working gas pressure is arranged in the hole 102 for valve on the closed end forming the bottom 61 of the working cylinder, see FIG. 3, which illustrates the working cylinder 3 of the gas spring of the assembly from FIGS. 1 and 2 in section in its longitudinal axis in the plane, in which the ride direction of the bicycle lies (i.e. according to the line 3-3 on FIG. 6). This hole 102 is connected with the internal space of the working cylinder 3 for passage of the working gas. Main working cylinder 3 is made integrally with the convex shape 1 corresponding to the seat post cradle shape, piston rod 5 in this example embodiment is made of ready-made duralumin tube.

In the example embodiment, the working gas is air, which is why it is possible to regulate the stiffness of the spring and possibly increase and decrease the working pressure e.g. based on the weight of the user using a common inflation pump. Air pressure in the cylinder will not exceed 15 bar, which is completely adequate.

FIG. 7a-d show details of throttle element 14 in various positions—different working modes. Throttle element 14 is sealingly placed on control rod 13 axially movably between upper backstop 131, created in the specific example embodiment by widening of the control rod 13, and lower backstop 132, created in the specific example embodiment by a nut screwed on the control rod 13. Screwing the control rod 13 out or in gradually opens or closes the transfer of springing fluid between working cylinder 3 and reservoir 51—space inside the piston rod 5. This causes increase or decrease of dampening intensity. Required settings could be handled by stepped stops (ball).

When the spring is compressed, positive pressure is created under piston 4 by reduction of the working space in working cylinder 3. The pressure, which is now higher than pressure in the space of the cavity of the piston rod 5, i.e. in the reservoir 51, raises the throttle element 14 (e.g. throttle ring), and this leads to pushing the throttle element 14 against the spring force of the silicone hose 134 (in case of sufficient intensity of compression up to the upper backstop 131 created on the control rod 13) and to the transfer of working medium from the working cylinder 3 into the reservoir 51 in piston rod 5. This position is illustrated in FIG. 7b. After the pressure on the spring subsides, the silicone tube 134 pushes the throttle element 14 downwards, which reduces the hole for transfer of the working fluid from the reservoir 51 back into the working cylinder 3, and the return of the spring caused by the expansion of the gas is thus dampened. Intensity of the dampening depends on the setting of external control, e.g. by adjustment lever 9, which adjusts the clearance size of the hole for passage of working fluid from the reservoir 51 back into the working cylinder 3. Silicone hose 134 around throttle element 14 has at the same time sealing function, when it prevents the air from passing through other places than the hole sealed by the throttle ring, and function of springing, when it presses the ring 14 to the hole.

At the time of highest dampening, see FIG. 7a, the throttle element 14 substantially abuts to the piston 4, and only minimum working fluid can pass from the reservoir 51 back into the working cylinder 3. Minimum dampening then happens, when the control lever is in the maximally drawn out position, see FIG. 7c. Throttle element 14, pushed away by silicone tube 134, in this situation abuts the lower backstop 132 in its highest position, which preserves the maximum hole for transferring the working fluid from the reservoir 51 into the working cylinder 3, and dampening is thus lowest. The position of the control rod and thus of both backstops 131 and 132 could be smoothly adjusted between these two extreme positions (FIGS. 7a and 7c) and thus the intensity of dampening could be set to any value between the highest and lowest dampening.

If the control rod 13 is inserted even further behind the position of maximum dampening illustrated in FIG. 7a, the upper backstop 131 is lowered and thus the maximum possible push away of the throttle element 14 against the action of the springing silicone tube 134 is reduced, which reduces the hole for passage of working fluid from the working cylinder 3 into the reservoir 51 during the compression of the spring (FIG. 7b) up to full arrestment, as shown in FIG. 7d, when the throttle element 14 is pushed by the upper backstop 131 to the upper side of the piston 4. In this second extreme position of the control rod, the throttle element 14 is thus gripped between the upper backstop 131 and upper side of the piston 4, and the working fluid could thus not be transferred between the working cylinder 3 and reservoir 51 anymore, even in case of compressing the spring, nor during its return, and gas spring thus springs only based on the compression of the volume of the working cylinder 3, without reservoir 51, and without any dampening during the return.

Seat, which consists of a soft seating part, is standardly equipped with two runners 121 from steel wire of 7 mm diameter. The gap between the runners 121 is 35 mm. The space between runners 121 and lower surface of the seating part is usually 40 mm. We succeeded in placing a significant part of the spring, including control elements, into this space. A large advantage is the fact that the springing takes place vertically, perpendicularly to the plane of the terrain, contrary to the previous known solutions, where the spring is placed askew and with crossing, or follows a radius and the position of the bicycle rider to handlebars is changed.

It is apparent to a person skilled in the art that individual specific elements could be embodied differently, within common engineering ability of a person with ordinary skill in the art. Above described examples of specific embodiments do not limit the scope of protection, which is delimited by the appended claims.

### LIST OF REFERENCE NUMERALS

1 convex shape corresponding to the seat post cradle shape

101 bore

102 hole for valve

2 nut

3 working cylinder

32 protrusion of the working cylinder 3

4 piston

41 transfer hole

5 piston rod

51 reservoir

6 lid of the working cylinder 3

61 bottom of the working cylinder 3

7 seat holder

71 stack

72 stack arm

8 lid of the reservoir 51

9 adjustment control lever

10 tightening nut

11 seat holder screw

12 foot for clamping the runners 121 of the seat

121 seat runners

13 control rod

131 upper backstop

132 lower backstop

134 silicone hose

14 throttle element

1. A bicycle seat suspension assembly, comprising a gas spring, a seat holder and a device for attachment to a seat post,
wherein the gas spring is a compression gas spring with dampening, the gas spring having a working cylinder with a working cylinder bottom and a working cylinder lid, and a piston arranged therein for sliding, wherein a piston rod sealingly goes through the working cylinder lid, wherein a transfer hole for transfer of working gas between the working cylinder and a reservoir created inside the piston rod is arranged in the piston, wherein the transfer hole is provided with a throttle element, the throttle element being axially movably placed on a control rod, going sealingly through the lid of the reservoir,
wherein the seat holder is attached to the gas spring, not rotably in relation to the working cylinder, and the seat holder is fixedly connected with an end of the piston rod, the piston rod extending into the working cylinder with another end of the piston rod bearing the piston, and
wherein the device for attachment to the seat post is arranged at a closed end forming the working cylinder bottom.

2. The bicycle seat suspension assembly according to claim 1, wherein the seat holder is fixedly connected to a shack, which is fixedly connected with the lid of the reservoir of the piston rod, wherein the shack is put on the working cylinder and fits into an outer profile of the working cylinder for allowing linear axial movement with the piston rod relative to the working cylinder and at the same time preventing any rotational movement of the shack relative to the working cylinder.

3. The bicycle seat suspension assembly according to claim 1, wherein the throttle element is placed on the control rod axially movably between an upper backstop and lower backstop.

4. The bicycle seat suspension assembly according to claim 1, wherein the device for attachment to the seat post is formed as a convex shape corresponding to the seat post cradle shape, in which there is at least one threaded bore for fixing to the seat post cradle.

5. The bicycle seat suspension assembly according to claim 1, wherein a valve for refilling the working gas pressure is arranged at the closed end forming the working cylinder bottom.

6. The bicycle seat suspension assembly according to claim 5, wherein the working gas is air.

7. The bicycle seat suspension assembly according to claim 1, wherein an adjustment lever is arranged at the end of the control rod protruding out of the lid of the reservoir.

8. A bicycle seat with suspension for shock absorbing, comprising the bicycle seat suspension assembly according to claim 3, wherein runners of the seat are fastened to the seat holder using feet drawn tight by screws, and a convex shape corresponding to the seat post cradle shape is attached to the seat post cradle using a screw screwed into at least one threaded bore.

9. The bicycle seat according to claim 8, wherein the adjustment lever of the bicycle seat suspension assembly is manually accessible and adjustable using fingers, and the valve is configured and placed for filling using an inflation pump.

10. The bicycle seat according to claim 8, wherein at least one third of the length of the seat suspension assembly is hidden from the side view in the space between the seat runners and the seat.

11. The bicycle seat according to claim 8, wherein the extension of the gas spring is at least 25 mm.

12. The bicycle seat suspension assembly according to claim 2, wherein the throttle element is placed on the control rod axially movably between an upper backstop and lower backstop.

13. The bicycle seat suspension assembly according to claim 2, wherein the device for attachment to the seat post is formed as a convex shape corresponding to the seat post cradle shape, in which there is at least one threaded bore for fixing to the seat post cradle.

14. The bicycle seat suspension assembly according to claim 3, wherein the device for attachment to the seat post is formed as a convex shape corresponding to the seat post cradle shape, in which there is at least one threaded bore for fixing to the seat post cradle.

15. The bicycle seat suspension assembly according to claim 2, wherein a valve for refilling the working gas pressure is arranged at the closed end forming the working cylinder bottom.

16. The bicycle seat suspension assembly according to claim 3, wherein a valve for refilling the working gas pressure is arranged at the closed end forming the working cylinder bottom.

17. The bicycle seat suspension assembly according to claim 4, wherein a valve for refilling the working gas pressure is arranged at the closed end forming the working cylinder bottom.

18. The bicycle seat suspension assembly according to claim 2, wherein an adjustment lever is arranged at the end of the control rod protruding out of the lid of the reservoir.

19. The bicycle seat suspension assembly according to claim 3, wherein an adjustment lever is arranged at the end of the control rod protruding out of the lid of the reservoir.

20. The bicycle seat suspension assembly according to claim 4, wherein an adjustment lever is arranged at the end of the control rod protruding out of the lid of the reservoir.
